(19) United States
(12) Patent Application Publication
(10) Pub. No.: US 2011/0316902 A1
(43) Pub. Date: Dec. 29, 2011

(54) BACKLIGHT DEVICE AND DISPLAY APPARATUS

(75) Inventors: Toshiki Onishi, Osaka (JP); Hideyuki Nakanishi, Osaka (JP); Takahiro Kobayashi, Osaka (JP); Yoshio Umeda, Hyogo (JP); Akihiro Yamamura, Osaka (JP); Seiji Hamada, Osaka (JP)

(73) Assignee: PANASONIC CORPORATION, 571-8501 (JP)

(21) Appl. No.: 13/255,365

(22) PCT Filed: Sep. 29, 2010
(86) PCT No.: PCT/JP2010/005860

§ 371 Date: Sep. 8, 2011

(30) Foreign Application Priority Data
Oct. 2, 2009 (JP) 2009-230733

(51) Int. Cl. G09G 5/10; G09G 3/36

(52) U.S. Cl. 345/690; 345/102

(57) ABSTRACT

Provided is a backlight device, wherein when both the drive duty and the drive current are controlled in each of separated areas, the image quality is improved by preventing the change of luminance even when there is a difference between the adjustment resolutions of both the drive duty and the drive current. A light-emitting unit (121) comprises a plurality of light-emitting areas. A motion amount detecting unit (131) detects the motion amount of an image in each of a plurality of motion areas each corresponding to at least one or more light-emitting areas. A drive condition specifying unit specifies a drive condition including the duty and pulse height value of a drive pulse for causing each of the plurality of light-emitting areas to emit light, on the basis of the detected motion amount. A drive unit drives each of the plurality of light-emitting areas according to the specified drive condition. With one of the duty and the pulse height value of the drive pulse, the adjustment resolution of which of the drive unit with respect to the light emission luminance is lower, as a first parameter and the other the adjustment resolution of which is higher as a second parameter, the drive condition specifying unit determines the value of the first parameter on the basis of the detected motion amount, and thereafter determines the value of the second parameter on the basis of the determined value of the first parameter.

### TECHNICAL FIELD

The present invention relates a backlight apparatus and a display apparatus using the backlight apparatus.

### BACKGROUND ART

A non-self-luminous display apparatus typified by a liquid-crystal display apparatus has a backlight apparatus (to be also simply referred to as a “backlight” hereinafter) on a backside thereof. The display apparatus displays an image through a light modulating section that adjusts an amount of reflection or an amount of transmission of light radiated from the backlight depending on an image signal. In the display apparatus, in order to reduce blurring of a moving image appearing in a hold type driving display apparatus, a light source is intermittently lighted in synchronism with scanning of an image.

In general, in order to perform the intermittent lighting, a scheme that causes an entire light emitting area of the backlight to light at a predetermined timing (to be generally referred to as “backlight blink”) and a scheme that vertically divides the light emitting area of the backlight into a plurality of scanning areas as shown in FIG. 1 and causes the scanning areas to sequentially flash in synchronism with scanning of an image as shown in FIG. 2 (to be generally referred to as “backlight scanning”) are used.

For example, in a liquid display apparatus using a backlight blink scheme described in Patent Literature 1, it is determined whether an input image is a still image or a moving image, and a driving duty (to be also referred to as a “duty” hereinafter) and a driving current (to be also referred to as a “peak value” hereinafter) of a light source is controlled.

For example, in a liquid display apparatus using a backlight scanning scheme described in Patent Literature 2, driving duties of a light source are controlled in units of scanning areas depending on the magnitude of motion of an image.

### CITATION LIST

### Patent Literature

### PTL 1

Japanese Patent Publication No. 3535799

### PTL 2

Japanese Patent Application Laid-Open No. 2006-323300

### SUMMARY OF INVENTION

### Technical Problem

In a liquid crystal display apparatus described in Patent Literature 2, even though an input image is a moving image, when a partial image in a certain image area corresponding to a certain scanning area does not move, the scanning area is maintained without decreasing the driving duty of the scanning area. To be more specific, when duties of only the other scanning areas are decreased without decreasing a driving duty of the certain scanning area, a moving image resolution while suppressing blurring of the moving image.

In this case, in order to equally maintain brightness of all the scanning areas, a driving current of a scanning area the driving duty of which is decreased needs to be relatively increased.

In brightness control performed by a combination of the driving duty and the driving current, when adjusting resolutions of the driving duty and the driving current are different from each other, the number of optimal combinations of both the driving duties and the driving currents to maintain the same brightness with respect to motion is regulated by ones having low adjusting resolutions. As a result, a rounding error occurs in brightness control, and a combination in which a change in brightness can be visually recognized may be disadvantageously generated.

For example, when a light emitting diode (LED: Light Emitting Diode) is used as a light source, an LED driving IC (Integrated Circuit) generally called an LED driver is used to drive the LED. The LED driver drives an LED by pulse width modulation (PWM) based on command values of digitally set driving duty and a digitally set driving current. LED drivers can generally adjust driving duties in 1024 levels (10 bits) to 4096 levels (12 bits). Most LED drivers can adjust driving currents in only 64 levels (6 bits) to 256 levels (8 bits). Therefore, the number of combinations of driving duties and driving currents in which “the number of errors is small when brightness is maintained to be equal to each other” is regulated by the driving currents having small number of adjusting levels (gradation levels) (i.e. small adjusting resolutions). For examples, when the driving duty and the driving current can be adjusted in 4096 levels and 256 levels, respectively, the number of available combinations will be 256. Therefore, in this case, as can be expected in the past, after a driving duty is determined depending on motion, a driving current to maintain the same brightness is determined. In this case, although the driving duty is finely determined in 4096 levels, the gradation levels of the driving current are 256 levels. For this reason, in many cases, values other than a proximal value cannot be selected (generation of a rounding error). As a result, at values of some driving duties, a combination in which a change in brightness can be recognized by human eyes is generated, and image quality may be deteriorated.

In this manner, in a backlight apparatus that can control both a driving duty and a driving current in each of divided areas such as scanning areas, due to a difference between both the adjusting resolutions, deterioration of image quality may disadvantageously occur.

It is therefore an object of the present invention to provide a backlight apparatus and a display apparatus that can prevent a change in brightness to improve image quality when both the driving duty and the driving current are controlled in each of divided areas even though adjusting resolutions of both the driving duty and the driving current are different from each other.

### Solution to Problem

A backlight apparatus according to the present invention includes: a light emitting section having a plurality of light emitting areas; a motion amount detecting section that detects the amount of motion of an image in each of the plurality of moving areas corresponding to at least one of the light emitting areas; a driving condition designating section that designates a driving condition including the duty and peak value of a driving pulse to cause each of the plurality of light emitting areas to emit light; and a drive section that drives each of the plurality of light emitting areas according to the designated driving condition, the driving condition designating section sets one of the duty and the peak value of the driving pulse having a low adjusting resolution of the drive section with respect to a light emitting brightness as a first parameter, sets other one having a high adjusting resolution as a second parameter to determine a value of the first parameter based on the detected amount of motion, and then determines a value of the second parameter based on the determined value of the first parameter.

A display apparatus according to the present invention has the backlight apparatus and a light modulating section that modulates illumination lights from the plurality of light emitting areas depending on an image signal to display an image.

### Advantageous Effects of Invention

According to the present invention, when both a driving duty and a driving current are controlled for each divided area, even though adjusting resolutions of the driving duty and the driving current are different from each other, a change in brightness is prevented to make it possible to improve image quality.

### BRIEF DESCRIPTION OF DRAWINGS

FIG. 1 is a diagram showing an example of a conventional scanning area;

FIG. 2 is a diagram illustrating a conventional backlight scanning scheme;

FIG. 3 is a block diagram showing a configuration of a liquid crystal display apparatus serving as a display apparatus according to Embodiment 1 of the present invention;

FIG. 4A is a diagram showing a moving area to illustrate an image area, FIG. 4B is a diagram showing a brightness area to illustrate the image area, FIG. 4C is a diagram showing a scanning area to illustrate the image area, and FIG. 4D is a diagram showing the image area;

FIG. 5 is a diagram showing an image area and a scanning area of a liquid crystal panel according to the embodiment;

FIG. 6 is a diagram showing a light emitting areas of a display section in the embodiment;

FIG. 7 is a block diagram showing an example of a configuration of an LED driver according to the embodiment;

FIG. 8A is a diagram showing an example of a combination of a scanning area and a moving area when the number of moving areas is an integral multiple of the number of scanning areas;

FIG. 8B is a diagram showing an example of a combination of a scanning area and a moving area when the number of moving areas is an integral multiple of the number of scanning areas;

FIG. 8C is a diagram showing an example of a combination of scanning areas and moving areas when the number of scanning areas is equal to the number of moving areas;

FIG. 9 is a schematic diagram illustrating a principle of the present invention and showing a relationship between a duty and a peak value at which an average brightness can be kept at a constant level;

FIG. 10A is a graph for illustrating a principle of the present invention and concretely showing an example of a relationship between a duty and a peak value at which an average brightness can be kept at a constant level;

FIG. 10B is a graph in which coordinate axes in FIG. 10A are replaced;

FIG. 11A is a diagram illustrating a principle of the present invention and showing brightness control having a low resolution and brightness control having a high resolution to illustrate an image of a brightness control method according to the present invention;

FIG. 11B is a diagram illustrating a principle of the present invention and showing an order of brightness adjustment to illustrate an image of the brightness control method according to the present invention;

FIG. 12A is a graph for illustrating a principle of the present invention and showing a relationship between changes in duty and peak value to illustrate that the range of brightness variation for each change of the duty in one step increases when the peak value increases, and FIG. 12B is a graph for illustrating a principle of the present invention and showing an example of a waveform to illustrate that the range of brightness variation for each change of the duty in one step increases as the peak value increases.

FIG. 13 is a graph for illustrating a principle for explaining a principle of the present invention and showing that brightnesses may not be made equal to each other even by fine adjustment of a duty in a portion having a large peak value;

FIG. 14A is a graph for illustrating a principle of the present invention and showing a range of an available duty to illustrate limitation of a range of a peak value, FIG. 14B is a graph for illustrating a principle of the present invention and showing conversion from an amount of motion to a peak value to illustrate the limitation of the range of the peak value, and FIG. 14C is a graph for illustrating a principle of the present invention and showing a range the limited peak value to illustrate the limitation of the range of the peak value;

FIG. 15A is a graph for illustrating a principle of the present invention and showing an example of a light emitting duty and a peak value to illustrate a negative synergistic effect achieved when backlight scanning and local dimming are combined with each other, FIG. 15B is a graph for illustrating a principle of the present invention and showing an example of a light emitting duty and a peak value that are different from those in FIG. 15A to illustrate the negative synergistic effect achieved when the backlight scanning and the local dimming are combined with each other, and FIG. 15C is a graph for illustrating a principle of the present invention and showing a comparison result between the brightness change of the example in FIG. 15A and the brightness change of the example in FIG. 15B to illustrate the negative synergistic effect achieved when the backlight scanning and the local dimming are combined with each other;

FIG. 16 is a graph for illustrating a principle of the present invention and for explaining a case where a resolution of a duty is unevenly set;

FIG. 17A is a graph for illustrating a principle of the present invention and for explaining a case where a resolution of a duty is not unevenly set in a graph showing a relationship between the peak value and the duty, and FIG. 17B is a diagram illustrating a principle of the present invention and for explaining a case where a resolution of a duty is unevenly set in the graph showing the relationship between the peak value and the duty;

FIG. 18 is a diagram showing a macro block segmented from an image area in the embodiment;

FIG. 19 is a block diagram showing a configuration of a motion amount detecting section in the embodiment;

FIG. 20 is a diagram showing a relationship between an LED driving pulse and a 1-frame period in the embodiment;

FIG. 21A is a diagram showing an example of an LED driving pulse output from an LED driver in the embodiment, and FIG. 21B is a diagram showing a duty of the LED driving pulse shown in FIG. 21A;

FIG. 22A is a diagram showing another example of the LED driving pulse output from the LED driver in the embodiment, and FIG. 22B is a diagram showing a duty of the LED driving pulse shown in FIG. 22A;

FIG. 23 is a block diagram showing another example of an LED driver in the embodiment;

FIG. 24 is a block diagram showing a configuration of a liquid crystal display apparatus having an LED driver in FIG. 23;

FIG. 25 is a block diagram showing a configuration of a liquid crystal display apparatus serving as a display apparatus according to Embodiment 2 of the present invention; and

FIG. 26 is a block diagram showing a configuration of a liquid crystal display apparatus serving as a display apparatus according to Embodiment 3 of the present invention.

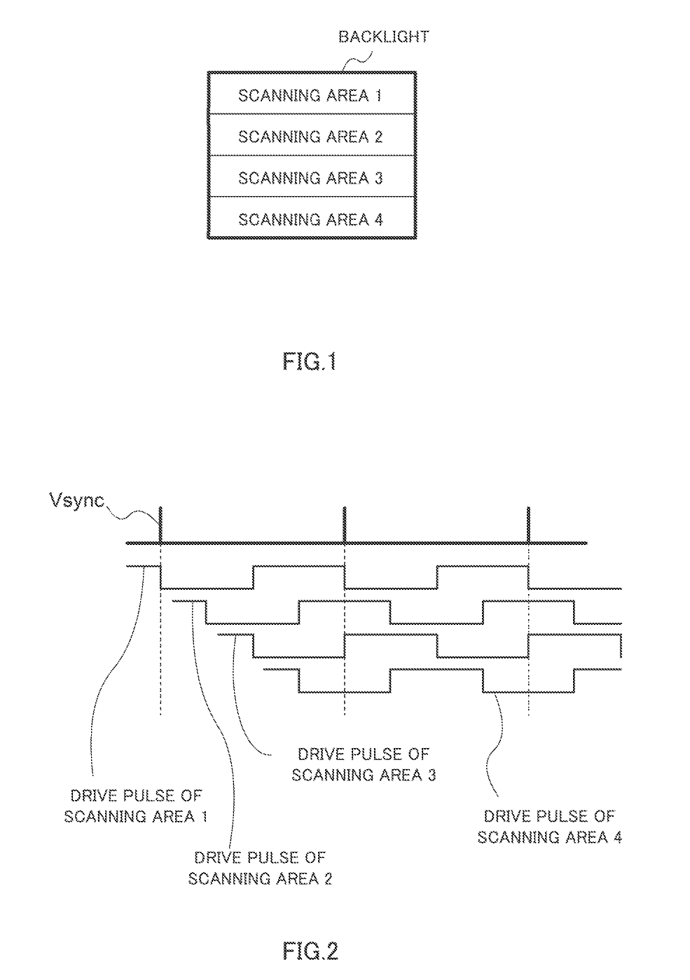

### DESCRIPTION OF EMBODIMENTS

Embodiments of the present invention will be described below in detail with reference to the accompanying drawings. In each of the embodiments, as a display apparatus, a liquid crystal display apparatus of an LED immediately-below type that directly radiates light of an LED from a backside of a liquid crystal panel will be described as a display apparatus.

### Embodiment 1

Embodiment 1 of the present invention will be described below.

In the embodiment, in a configuration obtained by combining backlight scanning and local dimming, a case where a driving current (peak value) of a driving pulse is determined first depending on motion will be described. The backlight scanning, as described above, is a technique that sequentially lights off scanning areas in synchronism with scanning of an image residual image to reduce a residual image (moving image blur), and the local dimming is a technique that controls brightnesses of light emitting areas in accordance with an image to improve contrast.

<1-1 Configuration of Liquid Crystal Display Apparatus>

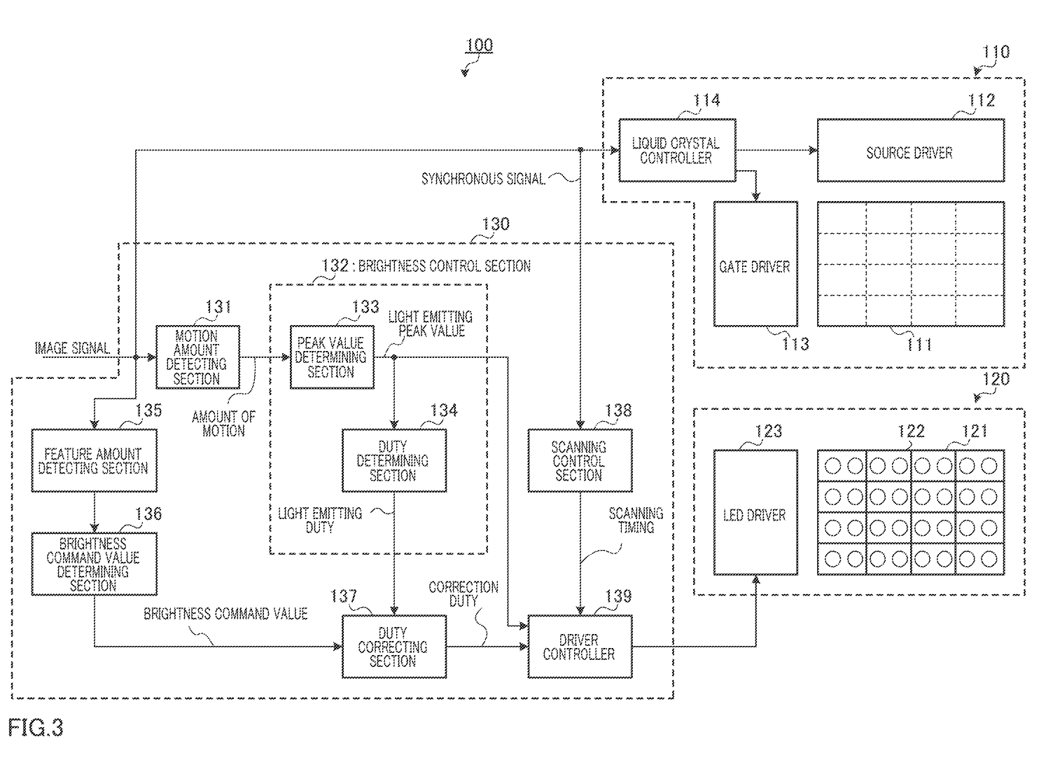

A configuration of a liquid crystal display apparatus will be described first. FIG. 3 is a block diagram showing a configuration of a liquid crystal display apparatus according to the embodiment. Liquid crystal display apparatus 100 shown in FIG. 3 has liquid crystal panel section 110, illuminating section 120, and drive control section 130. A configuration of illuminating section 120 and drive control section 130 configures a backlight apparatus.

Configurations of the sections will be described below in detail.

<1-1-1 Liquid Crystal Panel Section>

Liquid crystal panel 110 has liquid crystal panel 111, source driver 112, gate driver 113, and liquid crystal controller 114.

In liquid crystal panel 110, signal voltages are given from source driver 112 and gate driver 113 to pixels of liquid crystal panel 111 serving as a display section at a timing controlled by liquid crystal controller 114 to control a transmittance. Therefore, liquid crystal panel 111 can modulate an illumination light radiated from the backside of liquid crystal panel 111 depending on the image signals. In this manner, the image can be displayed in an image area having a large number of pixels. To be more specific, liquid crystal panel 110 configures a light modulating section.

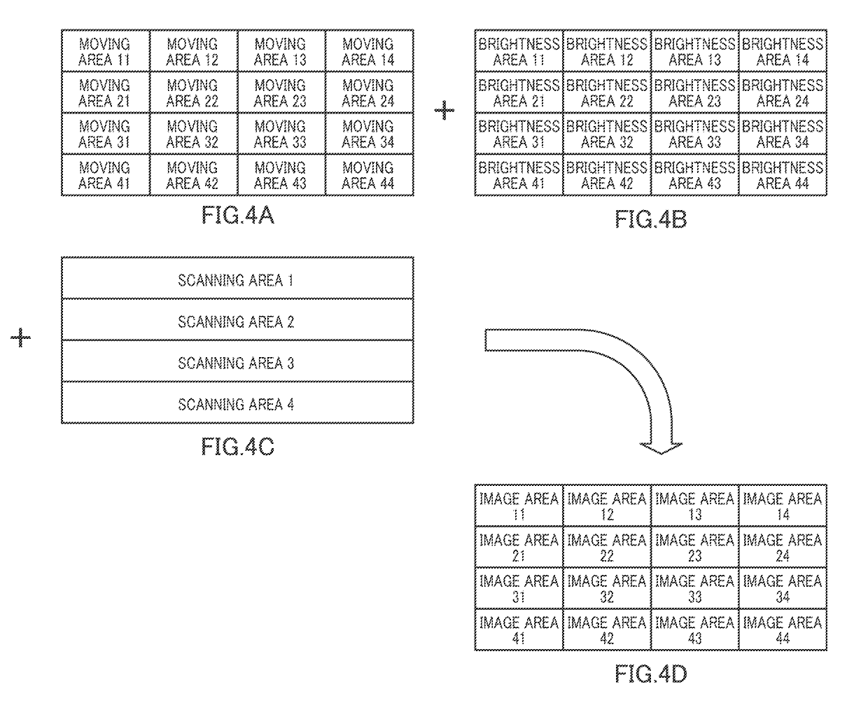

In this case, an area (to be referred to as an “image area” hereinafter) that displays an image on liquid crystal panel 111 shown in FIG. 3 is partitioned by broken lines. This clearly shows that liquid crystal panel 111 has a plurality of image areas and does not mean that liquid crystal panel 111 is structurally divided or that the lines are displayed in the image. The image area is obtained by overlapping a virtual boundary (see FIG. 4A) between areas (to be referred to as “moving areas” hereinafter) serving as units that is referred in detection of an amount of motion (will be described later), a virtual boundary (see FIG. 4B) between areas (to be referred to as “brightness areas” hereinafter) serving as units in which feature amounts to perform local dimming, and a virtual boundary (see FIG. 4C) between areas (to be referred to as “scanning areas” hereinafter) vertically divided into a plurality of areas and corresponding to backlight scanning.

In the embodiment, for example, as shown in FIG. 4D, liquid crystal panel 111 will be described such that liquid crystal panel 111 has, image areas, 16 (=4×4) image areas 11 to 44 obtained by dividing an entire screen in the form of a matrix.

Although liquid crystal panel 111 is not specified, a panel using an IPS (In Plane Switching) scheme, a VA (Vertical Alignment) scheme, or the like can be used.

<1-1-2 Illuminating Section>

Illuminating section 120 emits an illumination light to display an image on liquid crystal panel 111 and radiates illumination light from the backside of liquid crystal panel 111 onto liquid crystal panel 111.

Illuminating section 120 has light emitting section 121. Light emitting section 121 employs a so-called direct-type configuration. Light emitting section 121 is arranged to face the backside of liquid crystal panel 111, and a large number of point-like light sources are arranged in the form of a plane along the backside of liquid crystal panel 111 so as to emit lights towards the LCP 111. Thereafter, light emitting section 121 emits the light generated from the light source and being incident on the backside from a front surface side.

In the embodiment, LEDs 122 are used as point-like light sources are used. All LEDs 122 emit white lights, and are configured to emit equal brightness when LEDs 122 are driven under the same driving conditions. Each of LEDs 122 may emit a white light by itself or may be configured to emit a white light by mixing RGB lights.

As the point-like light sources, light sources except for LEDs may be used, or light sources that emit lights except for white lights may be used.

In this case, in FIG. 3, a light emitting surface of light emitting section 121 is partitioned by a solid line. This means that light emitting section 121 is independently controlled in units partitioned by the solid line. Light emitting section 121 determines motion of each of the moving areas of liquid crystal panel 111 to determine a driving duty and a driving current of an LED of corresponding light emitting section 121. For this reason, the LEDs need to be controlled in at least corresponding moving areas. Light emitting section 121, in local dimming, controls the driving duties of the corresponding LEDs of light emitting section 121 in units of the brightness areas of liquid crystal panel 111. For this reason, the LEDs need to be controlled at least in units of corresponding brightness areas. Light emitting section 121, in backlight scanning, ON/OFF-controls the corresponding LEDs of light emitting section 121 in units of the scanning areas of liquid crystal panel 111. For this reason, the LEDs need to be controlled in units of scanning areas in which scanning is performed, at least at a plurality of timings. In the embodiment, as shown in FIG. 5, light emitting section 121 has four-phase scanning areas corresponding to four phases of image areas shown in FIG. 4D in the vertical direction. In the example shown in FIG. 5, image areas 11 to 14 are included in scanning area 1, and image areas 21 to 24 are included in scanning area 2, image areas 31 to 34 are included in scanning area 3, and image areas 41 to 44 are included in scanning area 4.

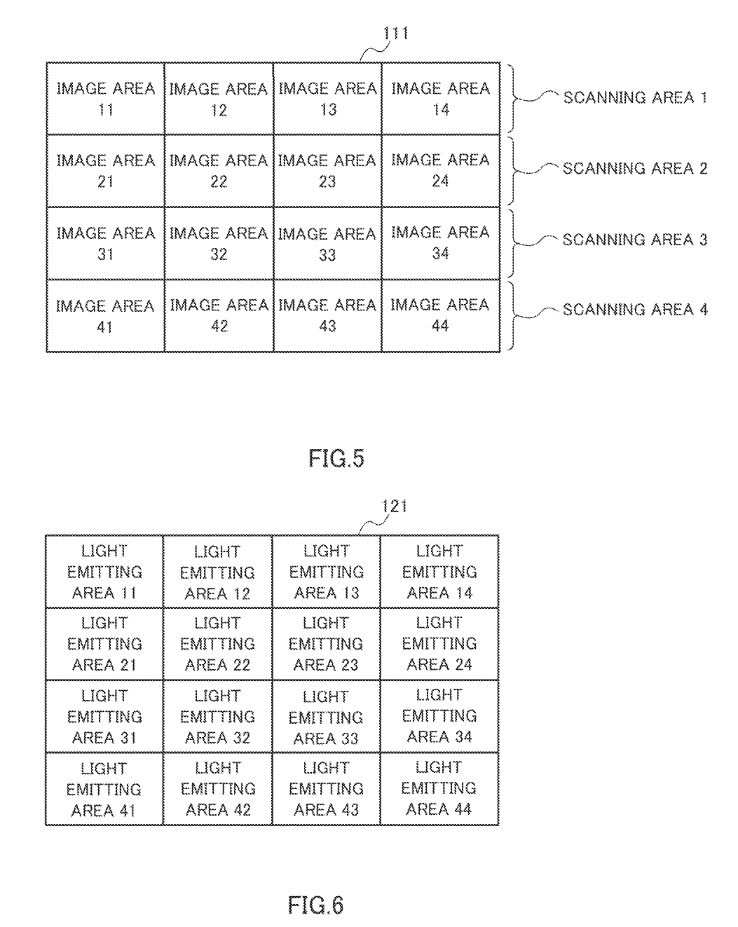

As a result, the areas (to be referred to as “light emitting areas” hereinafter) serving as control units of the LEDs of light emitting section 121 are shown in FIG. 6. Light emitting section 121 has 16 (=4×4) light emitting areas 11 to 44 obtained by dividing the entire light emitting surface in the form of a matrix.

The numbers of areas shown in FIGS. 4, 5, and 6 are only examples for ease of explanation. As a matter of course, the numbers of areas are not limited to the examples.

Illuminating section 120 has LED driver 123 serving as a drive section that drives LED 122. LED driver 123 has driving terminals the number of which is equal to the number of light emitting areas to make it possible to independently drive the light emitting areas.

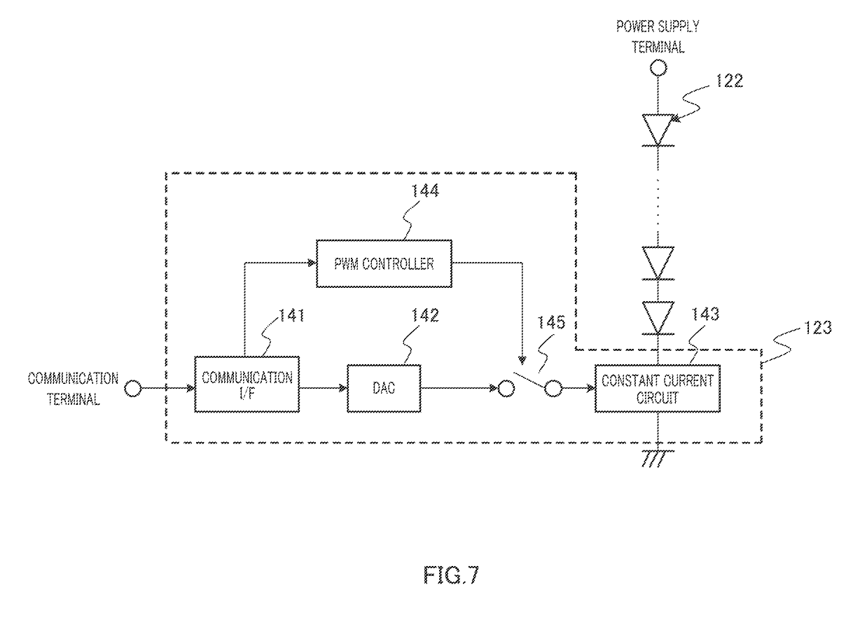

FIG. 7 shows an example of the configuration of LED driver 123. LED driver 123 has communication interface (I/F) 141 that decodes a peak value and a duty transmitted from drive control section 130 according to a specific communication protocol and information related to a scanning timing, digital-to-analog converter (DAC) 142 that converts the peak value from communication interface (I/F) 141 into a current command signal serving as an analog signal, constant current circuit 143 that supplies currents to plurality of LEDs 122 connected in series with each other based on the current command signal, PWM controller 144 that outputs a PWM pulse based on the duty received from communication I/F 141 and the data related to the scanning timing, and switch 145 that makes it possible to input the current command signal from DAC 142 to constant current circuit 143 or blocks the current command signal. To be more specific, LED driver 123 is configured such that a current being in proportion to a signal voltage of the current command signal from constant current circuit 143 to LED 122 when switch 145 is in an ON state and the current supply is cut when the switch 145 is in an OFF state. In the embodiment, this configuration is equipped per light emitting area.

With the above configuration, LED driver 123 independently drives a plurality of light emitting areas according to driving conditions including a duty (ON duty) and a peak value of a driving pulse designated per light emitting area to make it possible to emit light. Since LED driver 123 can control a phase of a PWM pulse based on data related to a scanning timing, a phase of a driving pulse of each light emitting area can be controlled, and backlight scanning can be performed. In this manner, each light emitting area mainly radiate light on an image area facing the light emitting area in a state in which the light emitting area is arranged to face the image area corresponding to liquid crystal panel 111. It is mentioned here that the light emitting area “mainly radiates light” because an illumination light is also radiated on an image area that does not face the light emitting area.

<1-1-3. Driving Control Section>

Drive control section 130 is an arithmetic processing apparatus having motion amount detecting section 131, brightness control section 132, feature amount detecting section 135, brightness command value determining section 136, duty correcting section 137, scanning control section 138, and driver controller 139, and controls driving conditions including the duty and peak value of a driving pulse for each light emitting area based on an input image signal of each of the image areas. Brightness control section 132 has peak value determining section 133 and duty determining section 134. In drive control section 130, a combination of brightness control section 132 (peak value determining section 133 and duty determining section 134), duty correcting section 137, and scanning control section 138 configures a driving condition designating section that designates driving conditions to each light emitting area.

<1-1-3-1. Principle of the Invention>

A principle of the present invention will be described before sections of drive control section 130 will be described in detail.

As described above, in backlight scanning to reduce moving image blurring, in order to maintain the brightness of the scanning areas at the same level, a drive current needs to be increased with respect to a scanning area where the driving duty is reduced.

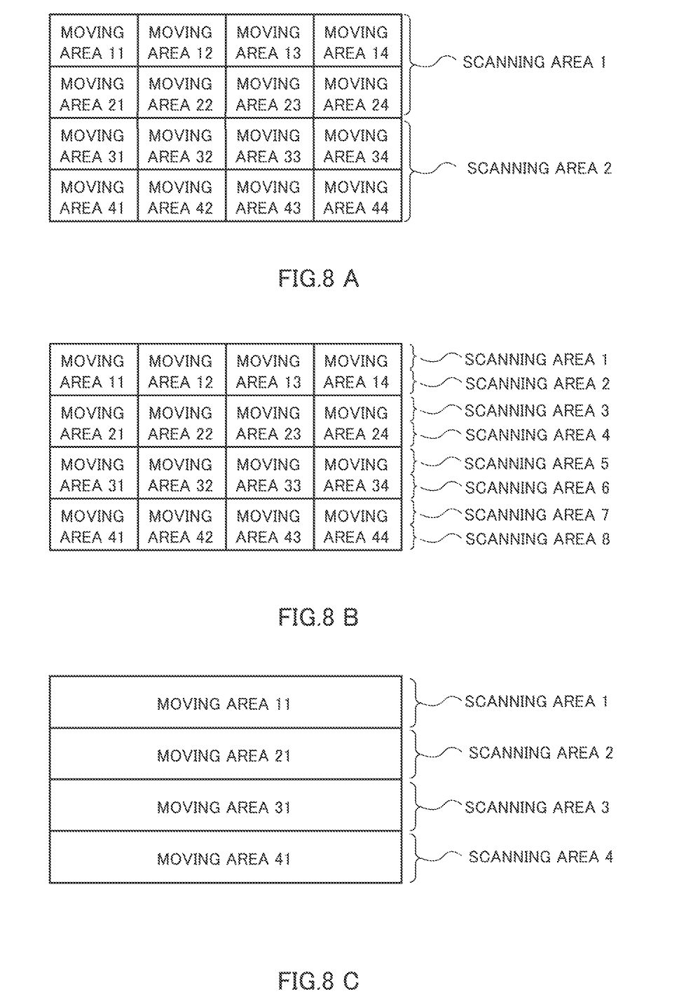

In this case, area units the scanning timings of which are controlled in the backlight scanning may be different from area units the current values of which are equal to each other in a vertical direction. To be more specific, the number of areas and the number of scanning areas in the vertical direction of the moving areas on liquid crystal panel 111 need not be always equal to each other. For example, as shown in FIG. 8A, the former may be an integral multiple of the latter, and as shown in FIG. 8B, the latter may be an integral multiple of the former. Alternatively, the numbers may be numbers other than the integral multiples, and the number of scanning areas need not be set with reference to the number of areas in the vertical direction of the moving areas. A configuration used when the numbers are not an integral multiple or when the numbers are not set with reference to the number of areas in the vertical direction of the moving areas is not preferable to suppress the number of areas in the vertical directions of the light emitting areas.

Furthermore, as shown in FIG. 8C, the moving areas may coincide with the scanning areas. In the embodiment, in particular, the scanning areas indicate areas obtained by dividing a pixel area into areas having equal scanning timings.

When the backlight scanning and the local dimming are combined with each other, the following operation can be conceived. After an optimal driving duty (to be also referred to as a “light emitting duty” hereinafter) is determined based on the amount of motion as a first step, based on the light emitting duty, a driving current (to be also referred as a light emitting peak value hereinafter). As the second step, by using a brightness command value of the local dimming, an optimal light emitting duty is normalized (corrected) to output the result as a corrected duty.

As described above, when an LED is used as a light source of a backlight, to drive the LED, in general, when a duty and a peak value are digitally set, an LED driver serving as an ID that PWM-drives the LED based on the setting is used. This is performed as shown in FIG. 7. LED drivers can generally adjust driving duties in 1024 levels (10 bits) to 4096 levels (12 bits). Most LED drivers can adjust driving currents in only 64 levels (6 bits) to 256 levels (8 bits). This is because the LED drive is not based on the assumption that a driving current (peak value) is adaptively changed, and is based on the assumption that, in general, after a current value is roughly set by an external resistor of an IC, fine adjustment is performed by an internal adjusting mechanism having about 64 steps (6 bits) to 256 steps (8 bits). In order to increase a gradation level of a peak value, a DAC having a high resolution is required to inevitably increase the cost.

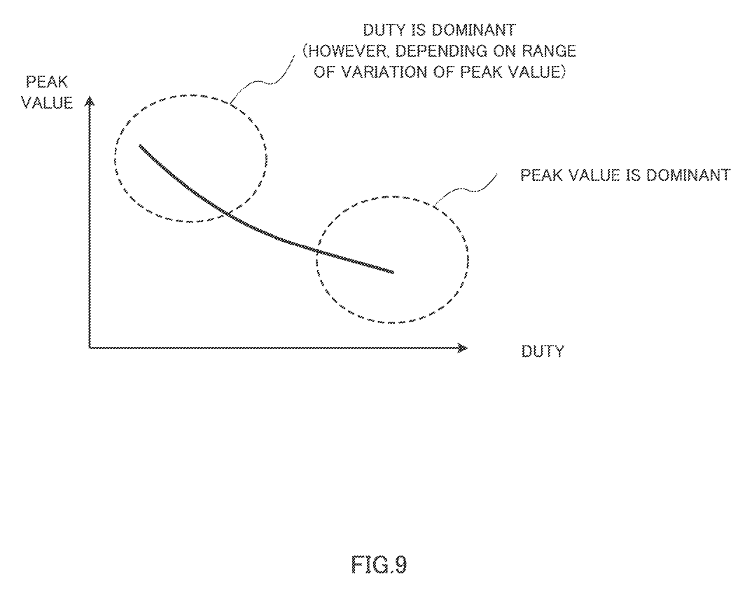

Therefore, necessarily, as described above, the number of combinations of duties and peak values “that have errors when the brightness is maintained at the same level” with respect to motion is regulated by the peak values having smaller numbers of adjusting levels (gradation levels) (i.e. having lower adjusting resolutions). For examples, when the driving duty and the driving current can be adjusted in 4096 levels and 256 levels, respectively, the number of available combinations will be 256. In this case, the range of variation of duty is relative and is obtained by dividing 0 to 100% of a 1-frame (1 V) cycle of an image displayed on a liquid crystal panel by 4096. In a narrow sense, a 1/4096 period can be arbitrarily set. This period is generally set as 1/4096 of a 1-V period. The range of variation of peak values changes depending on current-brightness characteristics of an LED, a brightness value to maintain, and so on. However, a change in brightness is larger when the duty is changed in one step than when the peak value is changed in one step. FIG. 9 is a schematic diagram showing a relationship between a duty and a peak value at which an average brightness can be kept constant.

Therefore, in this case, as can be expected in the past, after an OFF time (i.e. duty) is determined depending on motion, a driving current to maintain the same brightness is determined. In this case, although the driving duty is finely determined in 4096 levels, the gradation levels of the driving current are 256 levels. For this reason, in many cases, values other than a proximal value cannot be selected (generation of a rounding error). As a result, at some duty values, a combination in which a change in brightness can be recognized by human eyes is generated, and image quality may be deteriorated.

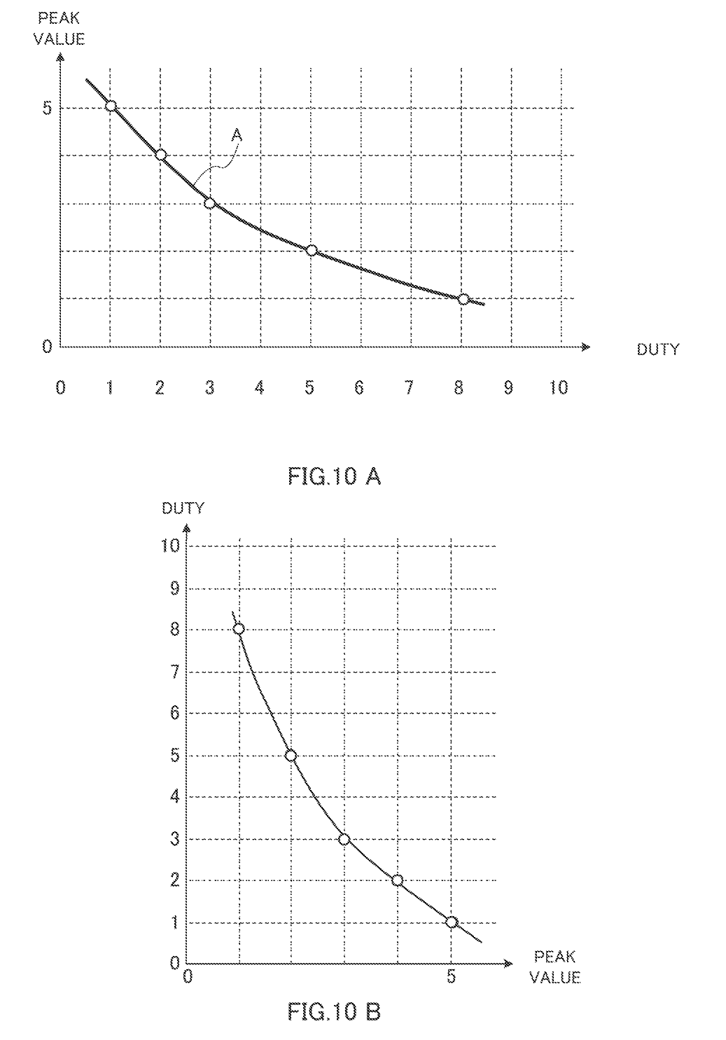

This will be explained in detail. FIG. 10A is a graph concretely showing an example of a relationship between a duty and a peak value at which an average brightness can be kept at a constant level. Curve A in FIG. 10A is an approximated curve (peak value=f (duty)) that represents a peak value as a function of a duty. FIG. 10B is a graph in which coordinate axes in FIG. 10A are replaced. In this case, for ease of explanation, the duty is represented in only 0 to 10 levels, and the peak value is represented in only 0 to 5 levels. The numbers of levels are not limited to the above numbers as a matter of course.

As shown in FIG. 10A, at a position of a white circle in FIG. 10A, it is assumed that a combination of a duty and a peak value at which almost equal brightness can be apparently obtained is present for one LSB (Least Significant Bit) of each of the peak values. At this time, when amount of motions at which duties 4, 6, 7, 9, and 10 are detected, as a corresponding wave length, a peak value at which a desired resolution cannot be given, and a rounded peak value can also be obtained through a transformation function (function of curve A) as a matter of convenience in a calculating process. However, when a combination of a peak value and a duty at which brightness is almost equal to each other (the difference cannot be recognized by human eyes) can be given to each of the resolution of peak values, a peak value is determined based on the amount of motion. Thereafter, when a duty is determined based on the peak value, the above problem cannot occur (see FIG. 10B).

Therefore, in the present invention, when an optimal combination of a duty and a peak value in backlight scanning is determined, first, one of the duty and the peak value having a lower adjusting resolution (in this case, the peak value) is determined based on the amount of motion. Thereafter, the other having a higher adjusting resolution (in this case, the duty) is determined.

As another method, for example, the amount of motion is evaluated in five steps, and a combination of a duty and a peak value at which brightness can be kept the same can also be held in the form of a table. However, as described above, in order to minimize moving image blurring and an electric power, the peak value and the duty are desirably adjusted in as many levels as possible. Therefore, in order to realize this, for example, it is better to hold a large number of combination tables such as 100 or 200 combination tables for each brightness in the apparatus than to transformation (determination of a duty and a peak value) by an approximate function calculated by measurement.

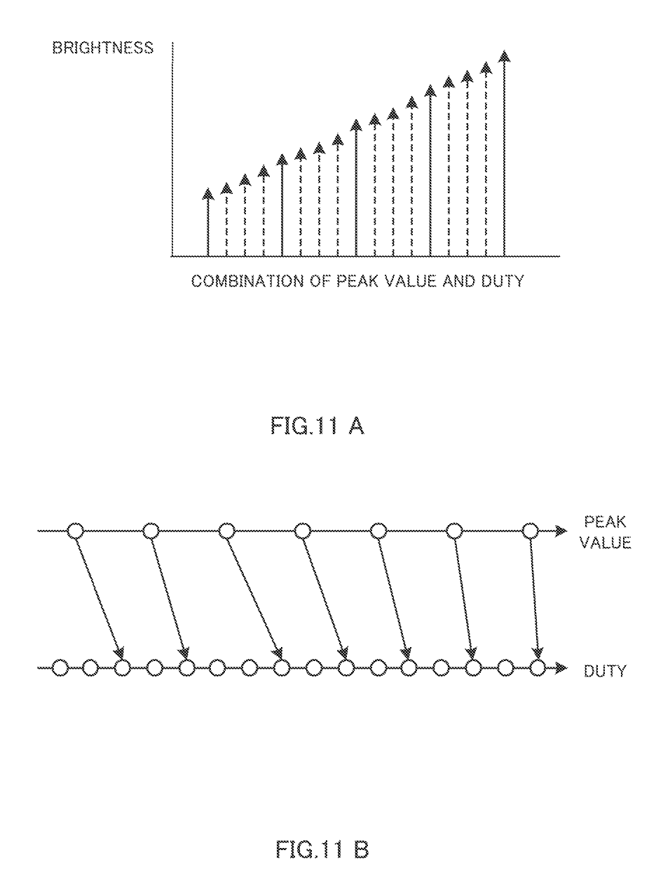

FIG. 11A and FIG. 11B are diagrams for illustrating images of a brightness control method according to the present invention. In the present invention, as shown in FIGS. 11A and 11B, after rough adjustment is imaginarily performed by a peak value, fine adjustment is performed by a duty to keep the brightness constant. In particular, as shown in FIG. 11A, in the present invention, a combination of a peak value and a duty is finely set depending on brightness. In FIG. 11A, a solid line indicates brightness adjustment performed by a peak value (i.e. can be applied by an adjusting resolution of a peak value), and a broken line indicates a manner in which a part of a resolution that is equal to or lower than the resolution of peak value adjustment is interpolated by the adjustment of the duty to smoothly switch the brightness. FIG. 11B shows a manner in which, when a combination of a duty and a resolution at which a brightness can be kept at a constant level is calculated, a corresponding value can be easily found in values (in this case, duties) each having a higher adjusting resolution by determining values each having a lower adjusting resolution.

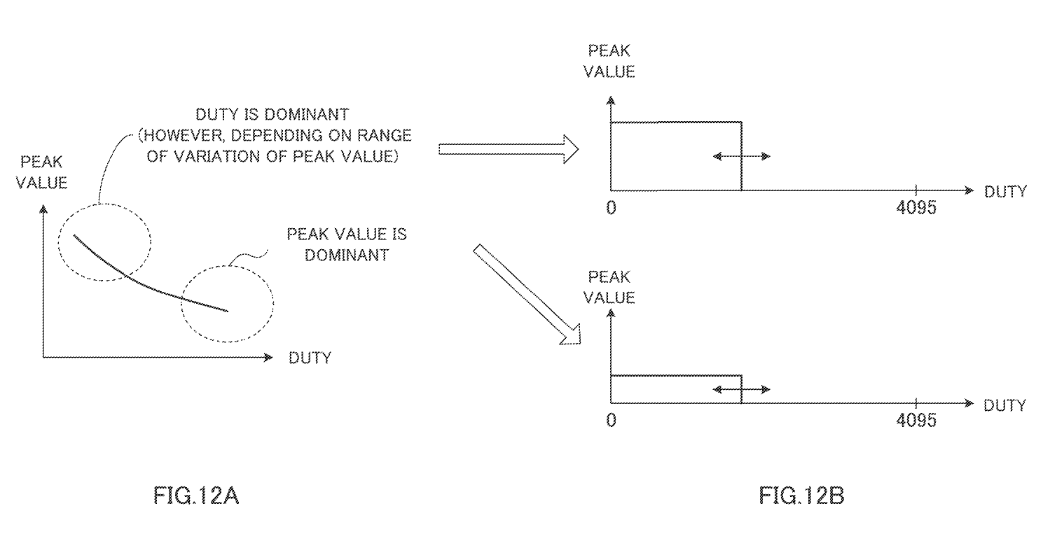

As described above, when the peak value increases, the range of variation of brightness obtained each time the duty is changed in one step increases (see FIG. 12). In particular, as shown in FIG. 12B, the range of variation of brightness obtained when the duty is changed by one LSB is clearly large when the peak value is large. This means that, in a part having a large peak value (i.e. a part exhibiting a large amount of motion), brightness is not matched with each other by fine adjustment by the duty (i.e. the brightnesses may exceed tolerance).

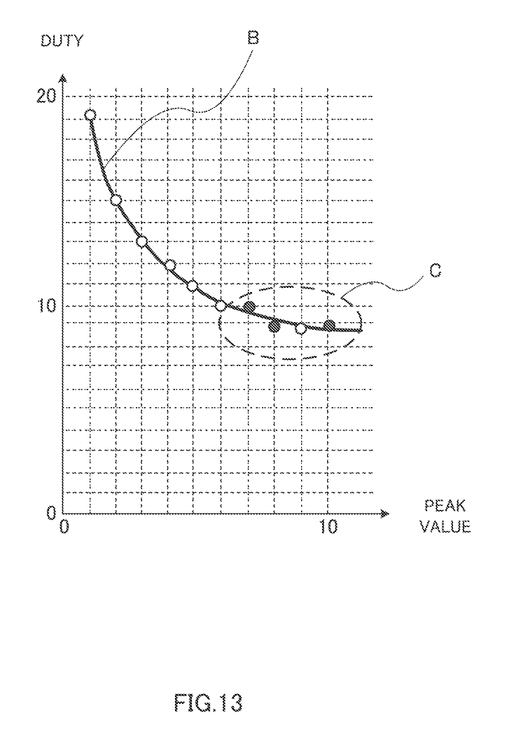

For example, FIG. 13 shows that brightness cannot be matched with each other by fine adjustment of a duty at a part having a large peak value. Curve B in FIG. 13 shows an identical brightness retention curve calculated by measurement. A white circle in FIG. 13 indicates, of combinations of peak values and duties that are closest to curve B, a combination having an allowable error from curve B (i.e. in which a change in brightness cannot be recognized by human eyes), and a black circle in FIG. 13 indicates, of combinations of peak values and duties that are closest to curve B, a combination having an unallowable error from curve B (i.e. in which a change in brightness can be recognized by human eyes). Region C in FIG. 13 indicates, on curve B, a part that a duty requires a resolution higher than that of one LSB and cannot cope with a change of one LSB of a peak value (however, as shown in FIG. 13, some parts may be matched by chance).

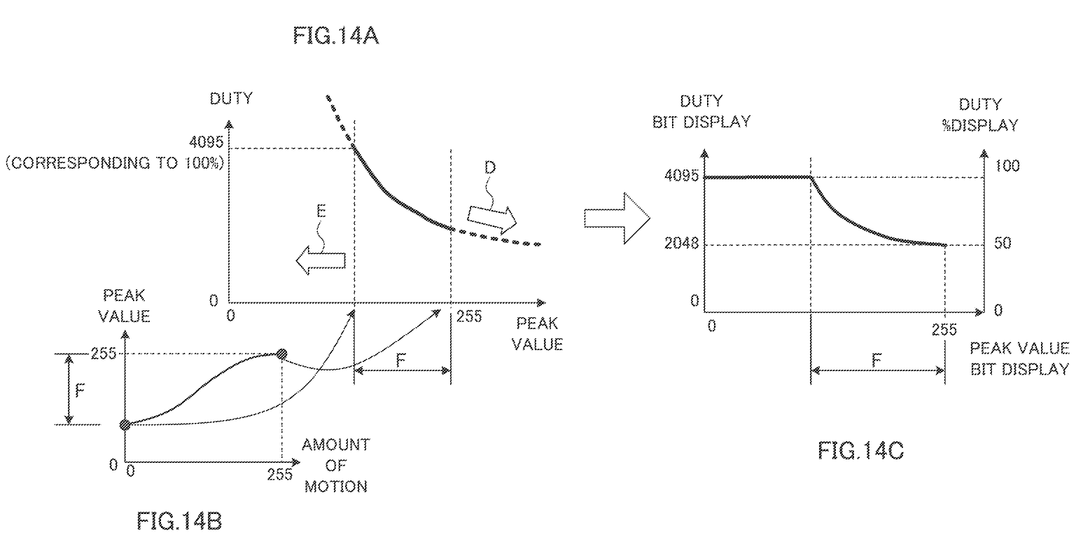

The problem, as shown in FIG. 14, may be handled by limiting the ranges of the wave values. In the example in FIG. 14, the resolution of adjustment of duty is set to 4096 levels, and the resolution of peak value adjustment is set to 256 levels. To be more specific, a range indicated by outline arrow D in FIG. 14A is avoided to be used. This is because the range corresponds to region C in FIG. 13 and it is probably impossible that the duty copes with a change of one LSB of a peak value. A range indicated by outline arrow E in FIG. 14A is avoided to be used. This is because the range is a part corresponding to a duty of 100% or more. To be more specific, the duty is not an absolute value and a relative value the maximum of which is 100%. For this reason, a part corresponding to 100% or more is limited. The brightness changes unless the range of the duty is restricted. Therefore, when a peak value is determined based on the amount of motion (i.e. the amount of motion is converted into the peak value), a peak value in the range indicated by outline arrow E is not employed. By the restrictions, the range of the peak value is limited to range F as shown in FIGS. 14A to 14C.

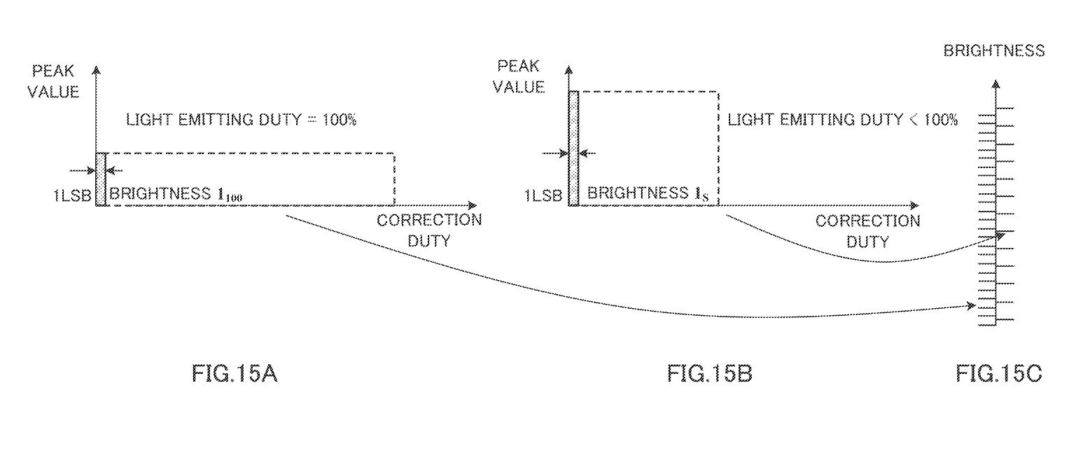

FIG. 15 is a graph for illustrating a case where not only backlight scanning but also local dimming are considered. When the handling shown in FIG. 14 is employed, a brightness command value in local dimming is more involved (see FIG. 3). Therefore, a problem in which a change in brightness by a change in one LSB of a duty increases when a peak value is large is effected by multiplying the change in backlight scanning and the change in local dimming (i.e. by a kind of the second power). To be more specific, for example, in comparison with a case where a light emitting duty (duty determined by backlight scanning) is 100% and a peak value is small (see FIG. 15A), when the light emitting duty is smaller than 100% and a peak value is large (see FIG. 15B), a change in brightness by a change in one LSB of a correction duty (duty obtained by multiplying the light emitting duty by a brightness command value of local dimming) increases (see FIG. 15C).

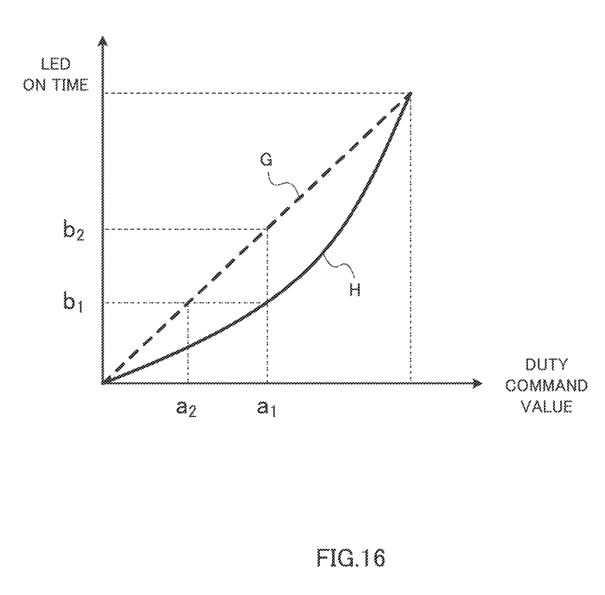

In order to solve the problem, the following measure is conceived. This is to unevenly set bits to a duty command value to an LED driver and an actual output control value from the LED driver. For example, as shown in FIG. 16, a relationship between a duty command value and an LED ON time (actual output control value) is set to a nonlinear relationship indicated by curve H in FIG. 16 but a conventional linear relationship indicated by straight line G in FIG. 16. To be more specific, for example, when a duty command value is given by a₁, the LED ON time is not set to b₁ (b₁<b) smaller than conventional b₂ but set to conventional b₂. A conventional duty command value corresponding to b₁ is a₂ (a₁>a2). This corresponds to that resolutions of a duty command value with respect to the LED ON time are unevenly set. To be more specific, the resolution of the duty command value with respect to the LED ON time is set to be coarse when the duty command value is large and is set to be dense when the duty command value is small.

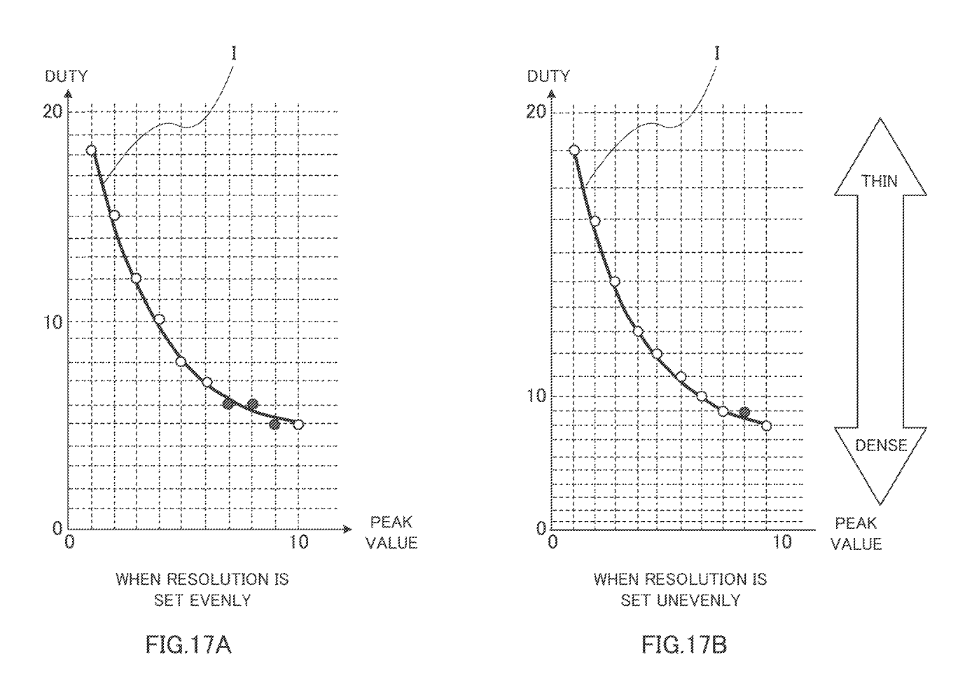

This also corresponds to, theoretically, as shown in FIG. 17B, that resolutions of duties are unevenly set in the diagram showing a relationship between a peak value and a duty. To be more specific, as shown in FIG. 17, the width of one LSB is narrowed when the duty is small (i.e. the resolutions are made dense when the duty is small and the resolution is made coarse when the duty is large). In this case, FIG. 17A shows a case where resolutions of duties are not unevenly set, and FIG. 17B shows a case where resolutions of duties are unevenly set. Curves I shown in FIGS. 17A and 17B are identical brightness retention curves calculated by measurement. White circles shown in FIGS. 17A and 17B indicate, combinations of peak values and duties that are closest to curve I, a combination having an allowable error from curve I (i.e. in which a change in brightness cannot be recognized by human eyes), and black circles shown in FIGS. 17A and 17B indicate, combinations of peak values and duties that are closest to curve I, a combination having an unallowable error from curve I (i.e. in which a change in brightness can be recognized by human eyes). As is apparent from FIGS. 17A and 17B, when the resolution of duty is uneven, a combination that keeps brightness at a constant level can be selected from a larger number of combinations and a wider range of combinations.

<1-1-3-2. Motion Amount Detecting Section>

Motion amount detecting section 131 detects the amount of motion of an image based on an input image signal. The amount of motion is not calculated as two values such as 50% and 100% but is calculated as many values such as 3 or more values.

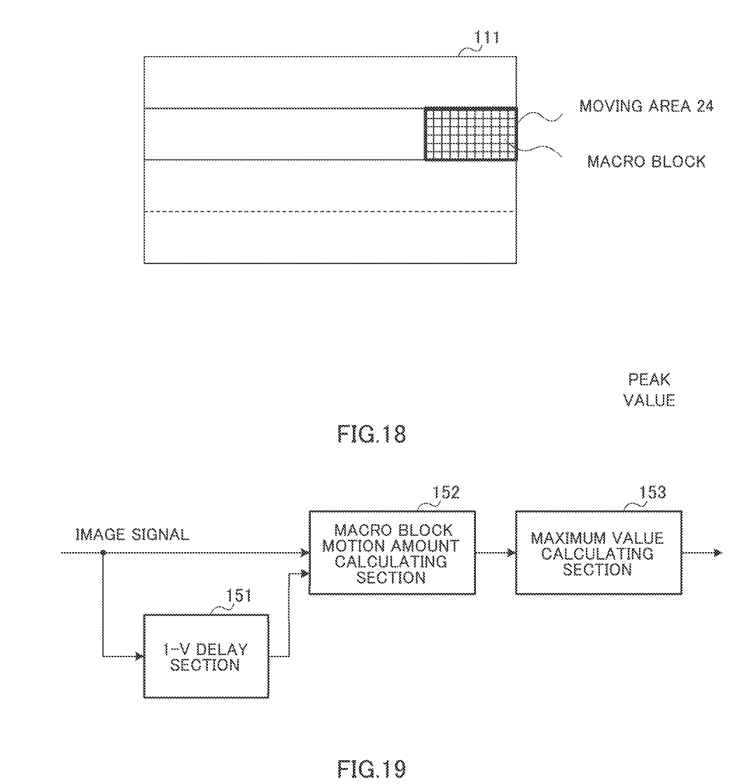

As a method of detecting the amount of motion, a method of calculating an amount of motion by pattern matching a current frame with a previous frame with respect to all macro blocks in units of macro blocks is known. In this case, the macro block is each area defined by segmenting a moving area. FIG. 18 shows a macro block in moving area 24 of liquid crystal panel 111. As a simpler amount of motion detecting method, a method using a magnitude of a difference between image signals of a current frame and a previous frame at the same pixel position in place of a result of pattern matching or the like is known.

In the embodiment, motion amount detecting section 131 employs a configuration in which a maximum value of an amount of motion of each macro block calculated by the method that is the former. To be more specific, when the maximum values of the moving areas when an image moves in an entire moving area and when an image moves in only a part of the moving area are equal to each other, the same values are output.

FIG. 19 shows a configuration of motion amount detecting section 131. Motion amount detecting section 131 has 1 V delay section 151 that delays an input image signal by 1 frame, a macro block motion amount calculating section 152 that calculates the amount of motion of an image for each macro block, and maximum value calculating section 153 that calculates a maximum value in the calculated amount of motions. This configuration is equipped for each of the moving areas.

With the configuration, motion amount detecting section 131 detects the amount of motion of an image for each moving area.

<1-1-3-3. Brightness Control Section>

Brightness control section 132 determines a light emitting peak value and a light emitting duty of each light emitting area based on the amount of motion detected by motion amount detecting section 131. In the embodiment, moving areas one-to-one correspond to light emitting areas. For this reason, brightness control section 132 determines a light emitting peak value and a light emitting duty of each corresponding light emitting area based on the amount of motion in each moving area. Depending on selection of the moving area, the brightness area, and the scanning area, a plurality of light emitting areas may be included in one moving area. In this case, in the plurality of light emitting areas, based on the same amount of motion, a light emitting peak value and a light emitting duty are consequently determined. In the embodiment, as described above, after the light emitting peak value is determined, the light emitting duty is determined. Brightness control section 132 has peak value determining section 133 and duty determining section 134.

Peak value determining section 133 determines a light emitting peak value for each light emitting area based on the amount of motion detected by motion amount detecting section 131. To be more specific, for example, peak value determining section 133 applies a predetermined transformation formula (for example, see FIG. 14B) to the amount of motion detected for each of the moving areas to calculate a light emitting peak value to each light emitting area, and the light emitting peak value is determined as a light emitting peak value designated per light emitting area.

Peak value determining section 133 generates current value data serving as a digital signal representing the determined peak value and outputs the current value data to LED driver 123 through driver controller 139 that controls communication with LED driver 123 of illuminating section 120. In this manner, a peak value is designated per light emitting area as a driving condition.

Duty determining section 134 determines a light emitting duty of each light emitting area based on the light emitting peak value determined by peak value determining section 133. To be more specific, for example, duty determining section 134 applies a predetermined transformation formula (for example, see FIG. 14A) to the light emitting peak value determined for each light emitting area to calculate a light emitting duty to each light emitting area, and the light emitting duty is determined as a light emitting duty designated per light emitting area. In this case, the predetermined transformation formula (for example, see FIG. 14) is an ideal brightness retention curve calculated by measurement as described above. Duty determining section 134 calculates a light emitting duty at which a brightness can be kept at a constant level based on the light emitting peak value determined for each light emitting area.

In this case, brightness control section 132 controls the light emitting duty to increase the light emitting duty as an amount of motion becomes smaller and controls the light emitting duty to decrease the light emitting duty when the amount of motion is large, and controls the light emitting peak value and the light emitting duty to keep a light emitting brightness serving as a result of the light emitting peak value and the light emitting duty at a predetermined value.

<1-1-3-4. Feature Amount Detecting Section>

Feature amount detecting section 135 detects a feature amount of the input image signal. To be more specific, feature amount detecting section 135 mainly detects a feature amount of the input image signal for each brightness area of liquid crystal panel 111. In this case, the “feature amount” is a feature amount related to the brightness of an image signal of each brightness area on liquid crystal panel 111. As the feature amount, for example, a maximum brightness level and a minimum brightness level of the image signal of each brightness area on liquid crystal panel 111, the difference between the maximum brightness level and the minimum brightness level, an average brightness level, and the like can be used. The “mainly” is added in the above description because final feature amounts of the brightness areas may be determined in consideration of the feature amounts of all the image signals and the feature amounts of a peripheral area of a brightness area to be calculated.

The brightness area may be obtained by arbitrarily equally dividing the entire area of liquid crystal panel 111, and need not always match with the moving area. The number of brightness areas in the vertical direction and the number of scanning areas in the vertical direction need not always be made equal to each other. In the embodiment, the brightness area, for simplicity, is divided by the same manner as that of division of the moving area. This is also applied to the subsequent embodiments.

<1-1-3-5. Brightness Command Value Determining Section>

Brightness command value determining section 136 determines a brightness command value of each light emitting area based on the amount of feature detected by feature amount detecting section 135. To be more specific, for example, brightness command value determining section 136 calculates a brightness value (brightness command value) at which each light emitting area should emit light from the detected feature amount by using a transformation table, a transformation function, and the like having predetermined characteristics. The brightness command value is set with reference to a brightness command value obtained when the light emitting duty is 100%. In the embodiment, brightness areas one-to-one correspond to light emitting areas. For this reason, brightness command value determining section 136 determines brightness command values for corresponding light emitting areas based on feature amounts of the brightness areas, respectively. Depending on selection of the moving area, the brightness area, and the scanning area, a plurality of light emitting areas may be included in one brightness area. In this case, the brightness command values are determined for a plurality of light emitting areas based on the same feature amount.

<1-1-3-6. Duty Correcting Section>

Duty correcting section 137 corrects the brightness command value determined by brightness command value determining section 136 based on a light emitting duty determined by duty determining section 134. To be more specific, for example, duty correcting section 137 is configured by a multiplier. The brightness command value determined by brightness command value determining section 136 is multiplied by the light emitting duty determined by the duty determining section 134 to determine a correction duty serving as a final light emitting duty. To be more specific, duty correcting section 137 normalizes (corrects) a brightness command value obtained by local dimming by using the light emitting duty obtained by detecting the amount of motion and outputs the result as a correction duty. To be more specific, for example, when the light emitting duty is 12-bit data, the brightness command value is 12-bit data, and the duty resolution of LED driver 123 is 12-bit data, a multiplication result between the light emitting duty and the brightness command value is 24-bit data. For this reason, only high 12 bits are extracted to perform normalization. The extraction of only the high 12 bits is equivalent to division by 4096 and normalization. Since the division is performed by using a special divider, it is merely described here that duty correcting section 137 performs multiplication by using a multiplier.

Duty correcting section 137 generates digital data representing the determined duty and outputs the digital duty to LED driver 123 through driver controller 139 that controls communication with LED driver 123 of illuminating section 120. In this manner, a duty is designated per light emitting area as a driving condition.

<1-1-3-7. Scanning Control Section>

Scanning control section 138 generates an ON start reference signal for each scanning area at a timing set with reference to a vertical sync signal of an image signal. The signal data is output to LED driver 123 through driver controller 139 that control communication with LED driver 123 of illuminating section 120 such that equal values are given to horizontal areas of the light emitting areas and vertical areas depend on the number of vertical areas and the number of scanning areas of the light emitting areas. In this manner, LED driver 1230N-controls LEDs based on the designated correction duty and the designated light emitting peak value at a desired scanning timing.

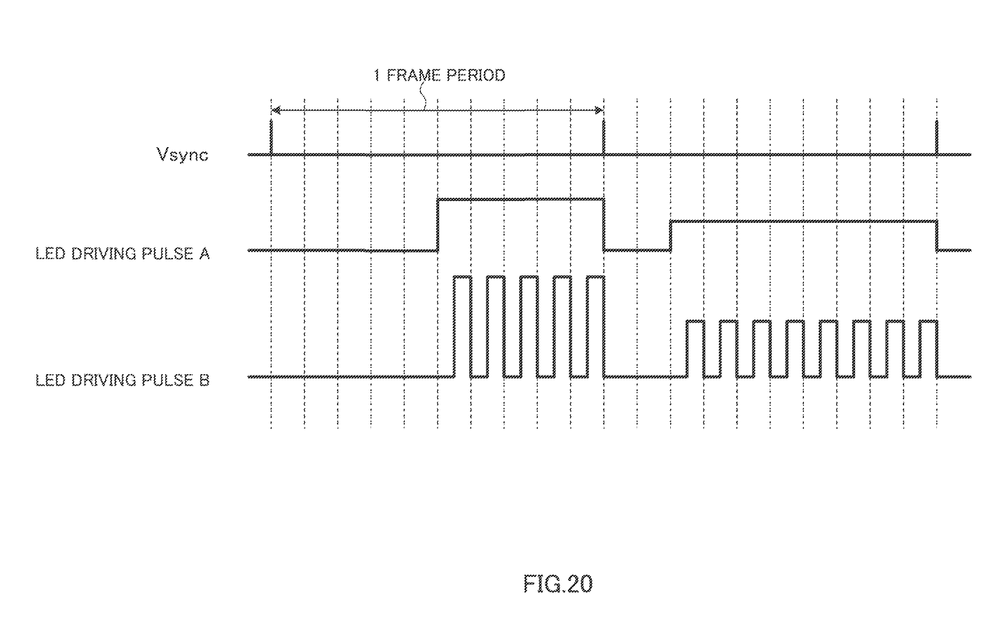

In this case, as indicated by LED driving pulse A in FIG. 20, in the embodiment, PWM controller 144 receives a PWM clock by driver controller 139 to have one pulse for one frame cycle of writing of liquid crystal panel 111. LED driving pulses A have equal average brightnesses in two continuous frame periods in FIG. 20. In this manner, a residual image reducing effect by narrowing a duty can be maximized. As a result, by scanning control section 138, backlight scanning in which the timing of the driving pulse is synchronized with the timing at which pixels of liquid crystal panel 111 are updated and scanned.

A driving pulse as indicated as LED driving pulse B in FIG. 20 may be supplied. LED driving pulses B have equal average brightnesses in two continuous frame periods in FIG. 20. LED driving pulse B has a plurality of pulses. A pulse generating period corresponds to an ON period of LED driving pulse A. Therefore, when LED driving pulse A is considered as an envelope curve thereof, it is easily imagined that the same effect as that of LED driving pulse A can be obtained.

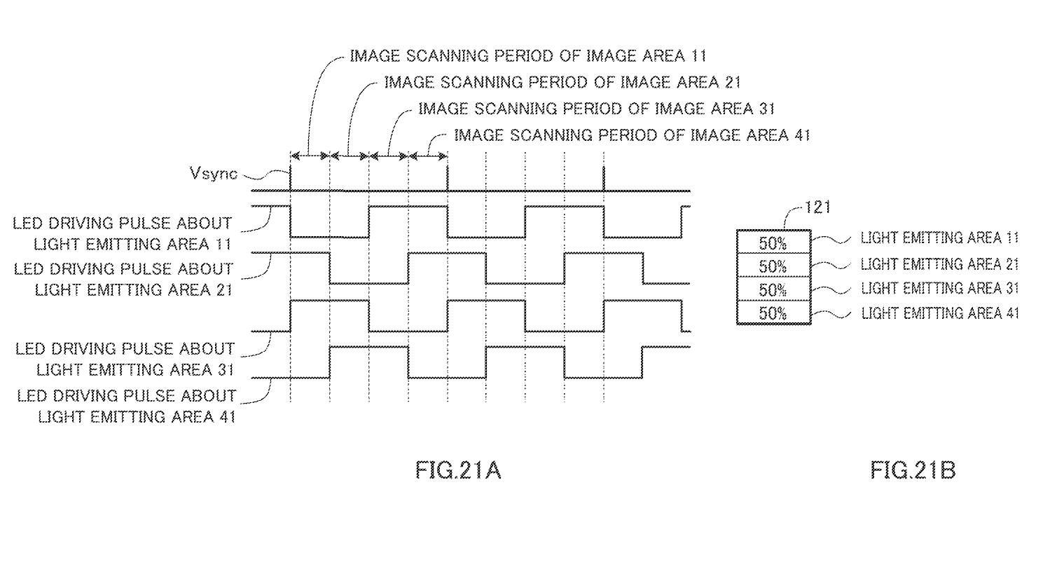

FIG. 21A shows an example of an LED driving pulse output from LED driver 123. In this case, as shown in FIG. 21B, a driving pulse output when all driving duties determined with respect to four light emitting areas 11, 21, 31, and 41 as shown in FIG. 21B are equal to each other (i.e. 50%). Since image scanning is performed to image area 11, image area 21, image area 31, and image area 41 in the order named, backlight scanning is also performed to light emitting area 11, light emitting area 21, light emitting area 31, and light emitting area 41 in the order named.

In the example shown in FIG. 21A, in an image scanning period of light emitting areas 11, 21, 31, and 41, timings at corresponding light emitting areas 11, 21, 31, and 41 are turned off are controlled. For this reason, a moving image resolution can be improved.

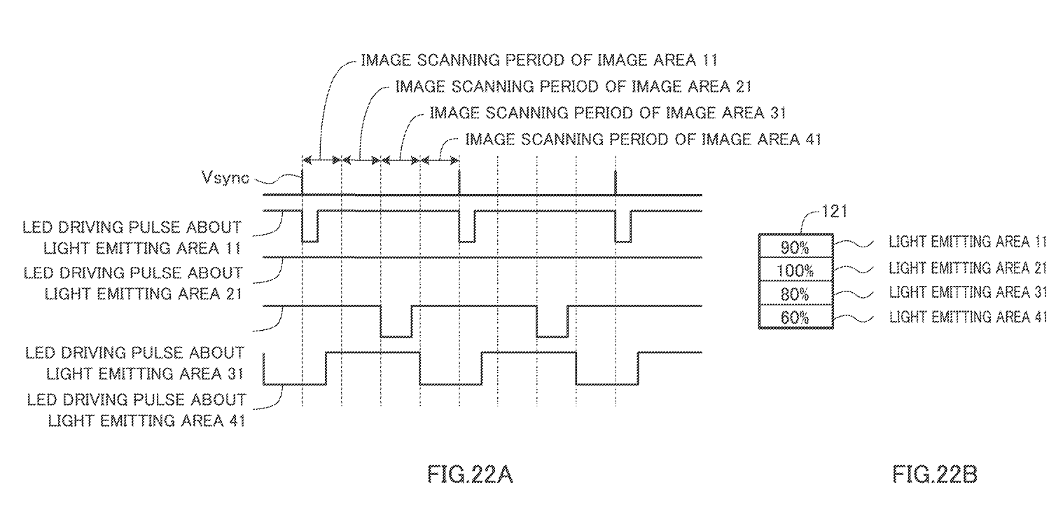

FIG. 22A shows another example of an LED driving pulse output from LED driver 123. In this case, as shown in FIG. 22B, drive pulses output when driving duties determined for four light emitting areas 11, 21, 31, and 41 are different from each other are shown. As shown in FIG. 22A, when the driving duties of light emitting areas 11, 21, 31, and 41 are changed, rising phases are more effectively changed without changing falling phases at driving pulses of light emitting areas 11, 21, 31, and 41. This is because, in this state, a period in which the response of a liquid crystal is more completed, corresponding pixels can be illuminated.

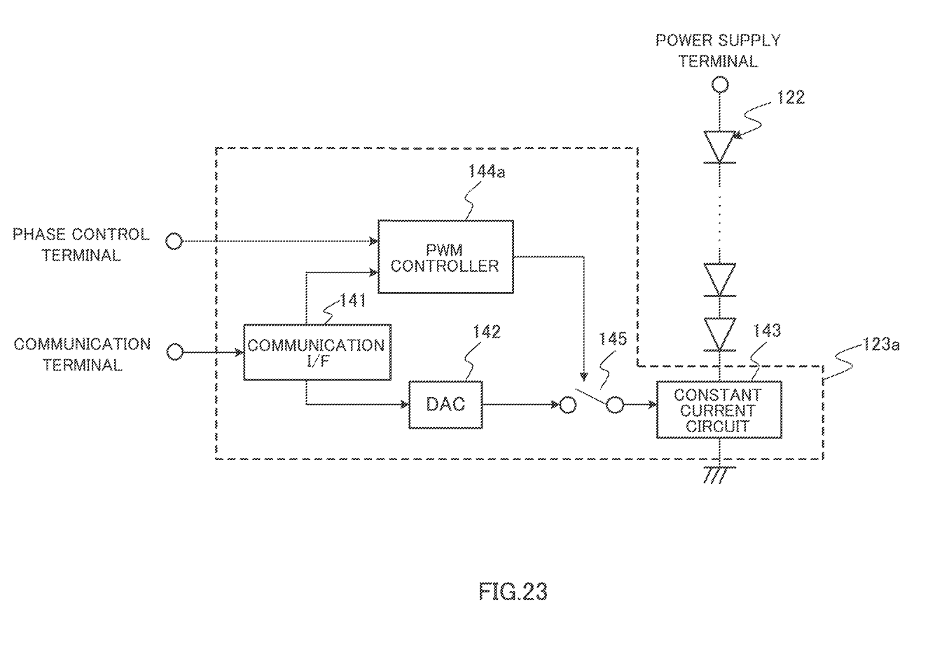

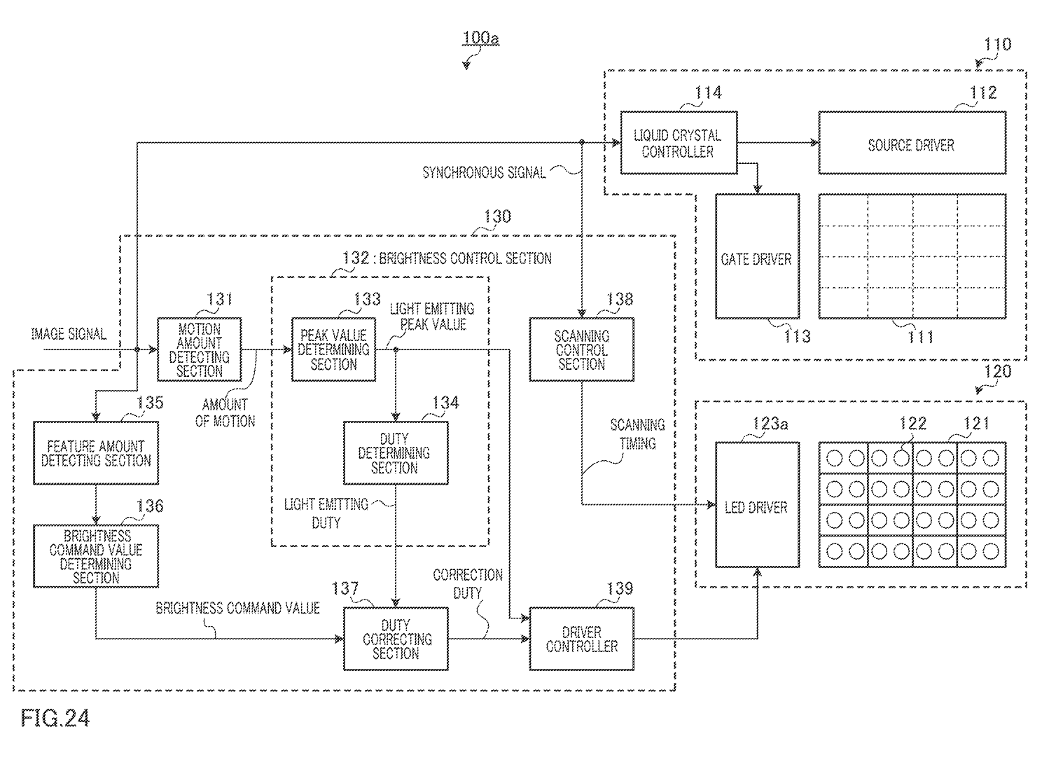

As the LED driver, an LED driver shown in FIG. 23 is known. LED driver 123a in FIG. 23 does not receive information related to a scanning timing from communication I/F 141 and has, as an external terminal serving as a phase control terminal, an internal counter reset signal of PWM controller 144a. In this case, a signal to the phase control terminal is directly supplied from scanning control section 138, and the configuration in FIG. 3 is changed into a configuration in FIG. 24. According to the configuration in FIG. 24, a start phase of a PWM pulse is controlled by the phase control terminal, and desired backlight scanning is realized.

<1-1-3-8. Driver Controller>

Driver controller 139 encodes a light emitting peak value, a correction duty, and a scanning timing sent as digital data according to a communication specification protocol required by LED driver 123 and transmits the encoded data to LED driver 123. As the protocol, serial communications such as I²C (Inter-Integrated Circuit), SPI (Serial Peripheral Interface), and RSDS (Reduced Swing Differential Signaling) are generally used.

In some LED driver, with respect to the scanning timing, a timing itself at which the data is transmitted serves as an ON start signal to a PWM controller. In this case, to each of the LED drivers, data of a light emitting peak value and a correction duty is consequently transmitted at a timing of corresponding backlight scanning.

Driver controller 139 supplies an operation clock of PWM controller 144 of LED driver 123 to have one pulse for one frame cycle of writing of liquid crystal panel 111.

The light emitting peak values and the correction duties the numbers of which are equal to the number of light emitting areas are not always input to driver controller 139. The light emitting peak values the number of which is equal to the number of moving areas and the correction duties the number of which is equal to the number of areas obtained by equally dividing the entire area of liquid crystal panel 111 in minimum units obtained when the moving areas and the brightness areas are virtually overlapped are input. When the same data need to be transmitted to the light emitting areas arranged across a plurality of areas in a horizontal or vertical direction, the data to be input is minimum, and copy control of the required data is performed by driver controller 139 by way of compensation to make it possible to reduce impossible calculations of the light emitting peak values and the correction duties. The same control as described above can also be performed by duty correcting section 137. In this case, light emitting duties the number of which is the minimum number of areas are sent to duty correcting section 137, and duty correcting section 137 preferably performs copy control as needed.

The configuration of liquid crystal display apparatus 100 has been described above.

<1-2. Operation of Liquid Crystal Display Apparatus>

An operation (overall operation) executed by entire liquid crystal display apparatus 100 having the above configuration will be described below with a central focus on characteristic operations of the present invention.

<1-2-1. Overall operation>

In the embodiment, when area boundaries between a moving area, a scanning area, and a brightness area are synthesized with each other, light emitting section 121 is controlled in units of minimum areas generated by the virtually synthesized area boundaries. Each of the areas of light emitting section 121 are used as light emitting areas, and a plurality of light emitting areas are independently driven according to driving conditions including duties and peak values of drive pulses independently designated to the light emitting areas.

Motion amount detecting section 131 detects the amount of motion of an image in units of moving areas based on the input image signal. The detected amount of motion is output to brightness control section 132.

Brightness control section 132 light emitting peak values and light emitting duties of the light emitting areas based on the amount of motion detected by motion amount detecting section 131. In this case, in the embodiment, in order to prevent image quality from being deteriorated due to a low resolution of peak value adjustment, after a light emitting peak value generally having a low adjusting resolution of an LED driver is determined, a light emitting duty having a high adjusting resolution is determined. To be more specific, peak value determining section 133 applies a predetermined transformation formula (for example, see FIG. 14B) to the amount of motion detected by motion amount detecting section 131 to determine a light emitting peak value for each light emitting area. Thereafter, duty determining section 134 applies a predetermined transformation formula (for example, see FIG. 14A) to the light emitting peak value determined for each light emitting area by peak value determining section 133 to determine a light emitting duty for each light emitting area. In this case, the light emitting duty is controlled to increase the light emitting duty when the amount of motion is small, and the light emitting duty is controlled to decrease the light emitting duty when the amount of motion is large. The light emitting peak value and the light emitting duty are controlled to keep a light emitting brightness serving as a result of the light emitting peak value and the light emitting duty at a predetermined value. The light emitting peak value determined by peak value determining section 133 is output to LED driver 123 of illuminating section 120. The light emitting duty determined by duty determining section 134 is output to duty correcting section 137.

On the other hand, in feature amount detecting section 135, a feature amount of the input image signal is detected in units of brightness areas. The detected feature amount is output to brightness command value determining section 136. Brightness command value determining section 136 determines a brightness command value for each light emitting area based on the feature amount detected by feature amount detecting section 135. The determined brightness command value is output to duty correcting section 137.

Duty correcting section 137 corrects the brightness command value determined by brightness command value determining section 136 based on the light emitting duty determined by duty determining section 134. To be more specific, the brightness command value determined by brightness command value determining section 136 is normalized with respect to the light emitting duty determined by duty determining section 134 to determine a correction duty serving as a final light emitting duty. The determined correction duty is output to LED driver 123 of illuminating section 120 through driver controller 139. At this time, in the embodiment, in order to cancel a negative synergistic effect achieved when backlight scanning and local dimming are combined with each other, resolutions of duty command values (correction duties) to LED driver 123 with respect to an LED ON time are unevenly set (for example, see FIG. 16).

On the other hand, scanning control section 138 generates an ON start reference signal for each scanning area at a timing set with reference to a vertical sync signal. The signal is output to LED driver 123 through driver controller 139 that controls communication with LED driver 123 of illuminating section 120.

Driver controller 139, based on the light emitting peak value, the correction duty, and the ON start reference signal representing a scanning timing, generates serial data encoded by a protocol required by communication I/F 141 of LED driver 123 and transmits the serial data to LED driver 123. In this manner, LED driver 1230N-controls LEDs based on the designated correction duty and the designated light emitting peak value at a desired scanning timing. An operation clock of PWM controller 144 of LED driver 123 is supplied to have one pulse for one frame cycle of writing of liquid crystal panel 111.

In this manner, the LEDs of the light emitting areas are PWM-driven by a desired light emitting peak value and a desired correction duty and at a desired driving timing.

In this manner, according to the embodiment, in the backlight scanning, when a duty and a peak value of a drive pulse are determined based on the detected amount of motion, after one (peak value) having a low adjusting resolution is determined first, the other (duty) having a high adjusting resolution is determined. For this reason, a gradation level error of a peak value can be cancelled in determination of a duty. Therefore, when both the duty and peak value of a driving pulse are controlled for each divided area, even though adjusting resolutions of the duty and the peak value are different from each other, a change in brightness is prevented to make it possible to improve image quality.

According to the embodiment, resolutions of duty command values to LED driver 123 with respect to an LED ON time (actual output control value from LED driver 123) are unevenly set, and the resolutions of the duty command values with respect to the LED ON time are set such that a large duty command value has a low resolution and a small duty command value has a high resolution. For this reason, a combination of a duty and a peak value that keeps brightness at a constant level can be selected from a larger number of combinations and a wider range of combinations. For this reason, a negative synergistic effect (when a large peak value is large, a change in brightness by a change in one LSB of a duty further increases) obtained when backlight scanning and local dimming are combined with each other can be canceled. Even though the backlight scanning and the local dimming are combined with each other, the change in brightness is prevented to make it possible to improve image quality.

In the description of the embodiment, the manners of dividing the moving area and the brightness area are equal to each other, and the number of scanning areas is equal to the number of vertical areas are equal to each other. However, the present invention is not limited to the manner and the number. For example, the present invention can be applied to a case where the manners of dividing the moving areas and the scanning area are equal to each other (for example, see FIG. 8C) and the brightness area is divided in the form of a matrix.

In the embodiment, the number of scanning areas is a plural number (four). However, for example, the number of scanning areas may be 1. With this configuration, in place of the backlight scanning, backlight blink control that is ON/OFF-control of the backlight is performed on the entire screen.

In the embodiment, only the resolution of duty is unevenly set. However, the resolution of peak values may be set unevenly, or both the resolution of duty and the resolution of peak values may be set unevenly.

In the description of the embodiment, the case where the resolution of peak value adjustment is lower than the resolution of adjustment of duty is exemplified. However, the embodiment is also can applicable to a case where the resolution of adjustment of duty is equal to the resolution of peak value adjustment.

### Embodiment 2

Embodiment 2 of the present invention will be described below. A liquid crystal display apparatus according to the embodiment has the same basic configuration as that of the liquid crystal display apparatus according to the embodiment described above. Therefore, the same reference numerals as in the above embodiment denote the same or corresponding constituent elements in Embodiment 2, and a description thereof will be omitted. Different points between Embodiment 2 and the embodiment described above will be mainly described below.

In the embodiment, a case where, in a combination obtained by combining backlight scanning and local dimming, a driving duty of a driving pulse is determined in advance depending on motion will be described.

<2-1. Configuration of Liquid Crystal Display Apparatus>

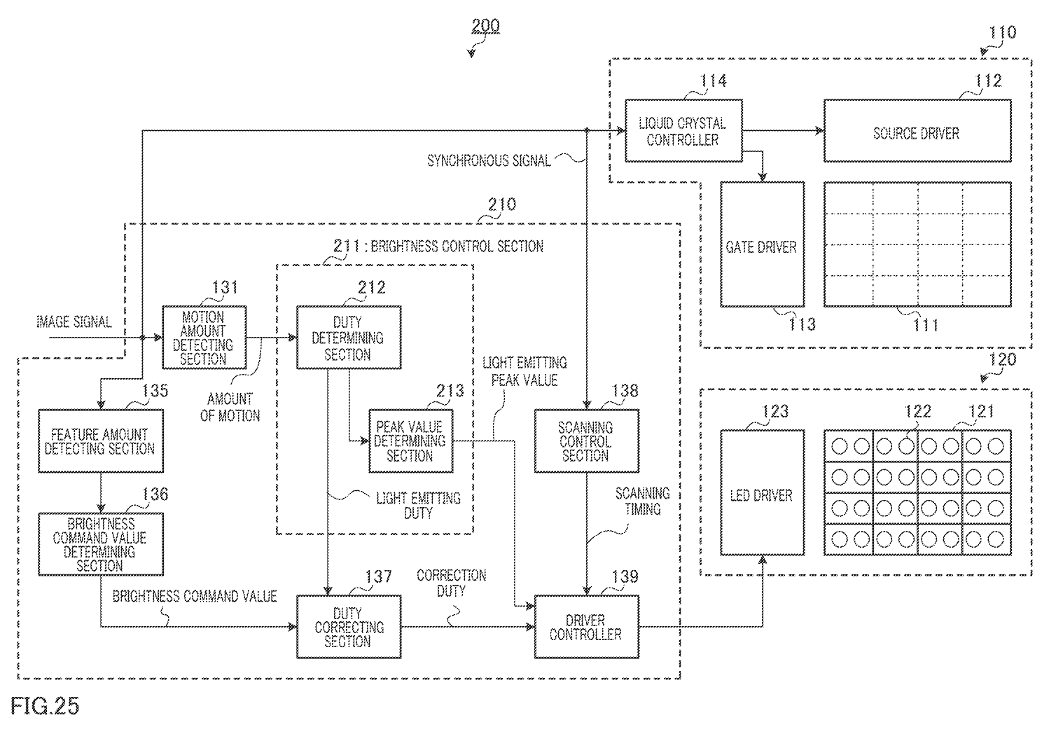

FIG. 25 is a block diagram showing a configuration of a liquid crystal display apparatus according to the embodiment. Liquid crystal display apparatus 200 shown in FIG. 25 has drive control section 210 in place of drive control section 130. Drive control section 210 is an arithmetic processing apparatus having motion amount detecting section 131, brightness control section 211, feature amount detecting section 135, brightness command value determining section 136, duty correcting section 137, scanning control section 138, and driver controller 139, and controls driving conditions including the duty and peak value of a driving pulse for each light emitting area based on an input image signal of each of the image areas. Brightness control section 211 has duty determining section 212 and peak value determining section 213. In drive control section 210, a combination between brightness control section 211 (duty determining section 212 and peak value determining section 213), duty correcting section 137, and scanning control section 138 configures a driving condition designating section that designates a driving condition to each light emitting area.

<2-1-1. Brightness Control Section>

Brightness control section 211, based on amount of motion detected by motion amount detecting section 131, determines a light emitting peak value and a light emitting duty of each light emitting area. In the embodiment, since a resolution of peak value adjustment is lower than an resolution of adjustment of duty, unlike in Embodiment 1, after the duty is determined, the light emitting peak value is determined. Brightness control section 211 has duty determining section 212 and peak value determining section 213.

Duty determining section 212 determines a light emitting duty of each light emitting area based on the amount of motion detected by motion amount detecting section 131. To be more specific, duty determining section 212 applies a predetermined transformation formula to the amount of motion detected for each of the image areas to calculate a light emitting duty for each light emitting area and determines the light emitting duty as a light emitting duty designated per light emitting area. For example, the light emitting duty comes close to 50% when the amount of motion is large, and the light emitting duty comes close to 100% when the amount of motion is small. A transformation function that is adjusted such that an apparent moving image resolution is constant even though any amount of motion is input is applied.

Peak value determining section 213 determines a light emitting peak value of each light emitting area based on a light emitting duty determined by duty determining section 212. To be more specific, peak value determining section 213 applies a predetermined transformation formula to the light emitting duty determined for each light emitting area to calculate a light emitting peak value to each light emitting area, and the light emitting peak value is determined as a light emitting peak value designated per light emitting area. In this case, the predetermined transformation formula, for example, is an ideal brightness retention curve calculated by measurement. Peak value determining section 213, by using the brightness retention curve, calculates a light emitting peak value at which a brightness can be kept at a constant level from the light emitting duty determined for each light emitting area.

In this manner, according to the embodiment, when the duty and peak value of a driving pulse are determined based on the detected amount of motion, after one (duty) having a low adjusting resolution is determined first, the other (peak value) having a high adjusting resolution is determined. For this reason, a gradation level error of a duty can be cancelled in determination of a peak value. Therefore, when both the duty and peak value of a driving pulse are controlled for each divided area, even though adjusting resolutions of the duty and the peak value are different from each other, a change in brightness is prevented to make it possible to improve image quality.

In the description of the embodiment, the case where the resolution of peak value adjustment is lower than the resolution of adjustment of duty is exemplified. However, the embodiment is also can applicable to a case where the resolution of adjustment of duty is equal to the resolution of peak value adjustment.

### Embodiment 3

Embodiment 3 of the present invention will be described below. A liquid crystal display apparatus according to the embodiment has the same basic configuration as that of the liquid crystal display apparatus according to the embodiment described above. Therefore, the same reference numerals as in the above embodiment denote the same or corresponding constituent elements in Embodiment 3, and a description thereof will be omitted. Different points between Embodiment 3 and the embodiment described above will be mainly described below.

In the embodiment, a case where an image signal is corrected based on a brightness command value will be described.

<3-1. Configuration of Liquid Crystal Display Apparatus>

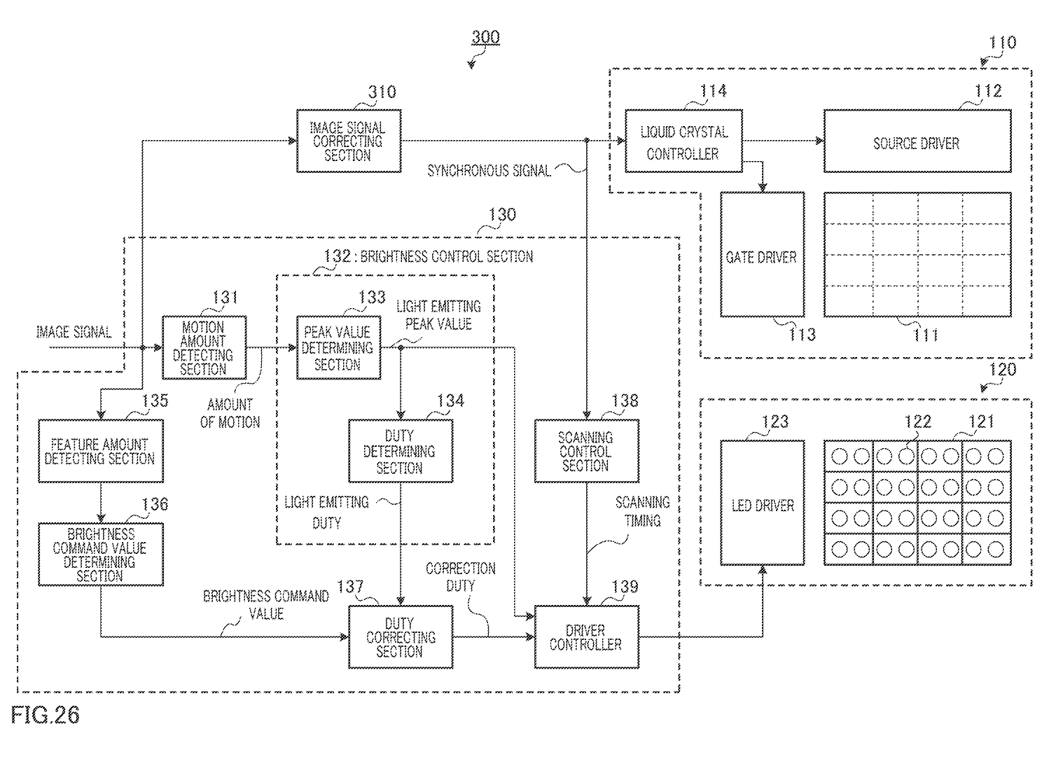

FIG. 26 is a block diagram showing a configuration of the liquid crystal display apparatus according to the embodiment. Liquid crystal display apparatus 300 shown in FIG. 26 has, in addition to the configuration of liquid crystal display apparatus 100 in Embodiment 1 shown in FIG. 3, image signal correcting section 310.

<3-1-1. Image Signal Correcting Section>

Image signal correcting section 310, based on a brightness command value determined by brightness command value determining section 136, corrects an image signal input to liquid crystal panel 110. To be more specific, image signal correcting section 310 corrects the image signal input to liquid crystal panel 110 by using a brightness command value of each of light emitting areas determined based on a feature amount of the image signal. In this manner, the image signal input to liquid crystal panel 110 is optimized depending on the brightness command values of the light emitting areas of light emitting section 121 corresponding to the image areas. Therefore, an image having higher contrast, higher gradient, and the like can be displayed.

In this manner, according to the embodiment, since the image signal input to liquid crystal panel 110 is optimized in consideration of a light emitting brightness of light emitting section 121 that illuminates a backside of liquid crystal panel 111, a vide image having higher contrast, higher gradient, and the like can be displayed.

Embodiments of the present invention have been described above. The above explanation is an exemplification of a preferred embodiment of the present invention, and the spirit and scope of the present invention are not limited to the embodiments. To be more specific, the configurations and the operations of the apparatus described in each of the embodiments are only illustrations. The configurations and the operations can be partially changed, added, and deleted without departing from the spirit and scope of the invention as a matter of course.

For example, each embodiment above exemplifies a case where the present invention is applied to a liquid crystal display apparatus. However, even though a light modulating section has a display section different from a liquid crystal panel, another non-self-luminous configuration can be employed. To be more specific, the present invention is also applicable to a non-self-luminous display apparatus except for a liquid crystal display apparatus.

Each of the embodiments exemplifies a case where the present invention is applied to a configuration obtained by combining backlight scanning and local dimming to a basic configuration that controls a driving duty and a driving current of an LED for each moving area. However, the present invention can be applied to a configuration that has only a portion for backlight scanning without having a portion for local dimming.

Furthermore, the present invention can be applied to an apparatus having only a basic configuration that controls a driving duty and a driving current of an LED for each moving area. To be more specific, the present invention can be applied to an apparatus having a configuration that controls both a driving duty and a driving current for each of divided areas.

In each of the embodiments, when a driver controller has a portion corresponding to a PWM controller section of an LED driver, or when an LED driver is only a constant current circuit and a driver controller has a PWM controller and a DAC in place of the LED driver (i.e. communication I/F is not necessary), the present invention can be applied. Resolution of the DAC is increased with respect to the resolution of the PWM controller because the same problem as described above is posed.

The disclosure of Japanese Patent Application No. 2009-230733, filed on Oct. 2, 2009, including the specification, drawings, and abstract, is incorporated herein by reference in its entirety.

### INDUSTRIAL APPLICABILITY

A backlight apparatus and a display apparatus according to the present invention have an advantage in which, when both a driving duty and a driving current are controlled for each of divided areas, even though the adjusting resolutions of both the driving duty and the driving current are different from each other, a change in brightness is prevented to make it possible to improve image quality. In particular, the backlight apparatus and the display apparatus are useful as a backlight apparatus and a display apparatus using a backlight scanning scheme and a combination of the backlight scanning scheme and a local dimming scheme.

### REFERENCE SIGNS LIST

100,100a, 200, 300 Liquid crystal display apparatus
110 Liquid crystal panel section
111 Liquid crystal panel
112 Source driver
113 Gate driver
114 Liquid crystal controller
120 Illuminating section
121 Light emitting section
122 LED
123, 123a LED driver
130, 210 Drive control section
131 Motion amount detecting section
132, 211 Brightness control section
133, 213 Peak value determining section
134, 212 Duty determining section
135 Feature amount detecting section
136 Brightness command value determining section
137 Duty correcting section
138 Scanning control section
139 Driver controller
141 Communication I/F
142 DAC
143 Constant current circuit
144, 144a PWM controller
145 Switch
151 1-V Delay section
152 Macro block motion amount calculating section
153 Maximum value calculating section

1. A backlight apparatus comprising:
a light emitting section having a plurality of light emitting areas;
a motion amount detecting section that detects the amount of motion of an image in each of a plurality of moving areas corresponding to at least one of the light emitting areas;
a driving condition designating section that designates driving conditions including the duty and peak value of a driving pulse to cause each of the plurality of light emitting areas to emit light based on the detected amount of motion; and
a drive section that drives each of the plurality of light emitting areas according to the designated driving conditions, wherein the driving condition designating section sets, of the duty and the peak value of the driving pulse, one having a lower adjusting resolution of the drive section with respect to a light emitting brightness as a first parameter and the other having a higher adjusting resolution as a second parameter, determines a value of the first parameter based on the detected amount of motion, and then determines a value of a second parameter based on the determined value of the first parameter.

2. The backlight apparatus according to claim 1, wherein the first parameter is a peak value of the driving pulse, and the second parameter is a duty of the driving pulse.

3. The backlight apparatus according to claim 1, wherein a resolution of a command value of a duty of the driving pulse to an output from the drive section is coarse when the command value of the duty of the driving pulse is large or is dense when the command value is small.

4. The backlight apparatus according to claim 1, further comprising:
a feature amount detecting section that detects a feature amount of an image signal in each of a plurality of brightness areas corresponding to at least one of the light emitting areas; and
a brightness command value determining section that determines a brightness command value for each brightness area based on the detected feature amount, wherein the driving condition designating section determines a peak value of the drive pulse to each of the plurality of light emitting areas based on the detected amount of motion, after a duty of the drive pulse is temporarily determined based on the determined peak value, the temporarily determined duty is corrected based on the determined brightness command value, and the drive section drives each of the plurality of light emitting areas according to the driving conditions including the determined peak value and the corrected duty.

5. The backlight apparatus according to claim 1, wherein the driving condition designating section designates the driving conditions such that one driving pulse corresponds to one frame cycle of the image signal for each of the plurality of light emitting areas.

6. The backlight apparatus according to claim 1, wherein the driving condition designating section has a scanning control section that controls a light emitting timing of the corresponding light emitting area in synchronism with scanning of an image for each of the plurality of scanning areas corresponding to at least one of the light emitting areas.

7. The backlight apparatus according to claim 1, wherein the light emitting section has a plurality of light emitting diodes as light sources.

8. A display apparatus comprising:
the backlight apparatus according to claim 1; and
a light modulating section that displays an image by modulating illumination lights from the plurality of light emitting areas depending on an image signal.
